(19) United States
(12) Patent Application Publication
(10) Pub. No.: US 2005/0016042 A1
(43) Pub. Date: Jan. 27, 2005

(54) Motion picture memorabilia and method for promoting motion pictures using same

(76) Inventor: Adam M. Baratta, Los Angeles, CA (US)

Correspondence Address: Sean D. Burdick, 21372 Ave. Manantial, Lake Forest, CA, 92630, US

(21) Appl. No.: 10/834,417

(22) Filed: Apr. 28, 2004

Related U.S. Application Data
(60) Provisional application No. 60/465,492, filed on Apr. 28, 2003.

(51) Int. Cl. G09F 21/02; G09F 3/18

(52) U.S. Cl. 40/701; 40/661; 40/586

(57) ABSTRACT

An article of memorabilia for promoting a motion picture, and method for promoting motion pictures using the article of memorabilia. An article may comprise a first plate, and a second plate attached to and substantially equivalent in size to the first plate, and comprising a transparent portion. A film segment comprising one or more frames of film is substantially contained between the first and second plates, and a means is provided for attaching the first plate to a surface such that the film segment is viewable through the transparent portion. A method for promoting public interest in viewing the motion picture for which the film was produced comprises acquiring film shot for the motion picture, manufacturing articles of memorabilia from a segment of the film, and disseminating the articles to moviegoers.

This application claims the benefit of U.S. Provisional Application No. 60/465,492 filed Apr. 28, 2003, which is hereby incorporated by reference herein as though set forth in full.

### BACKGROUND

1. Field of the Invention

This invention relates to the field of motion picture memorabilia, and methods for promoting motion pictures using motion picture memorabilia. More specifically, the invention relates to memorabilia such as bracelets containing viewable frames of film, and promotional methods involving the dissemination of memorabilia.

2. Related Art

For years film studios have generated literally millions of feet of excess film for every major motion picture produced. Over the course of filming a typical big-budget picture, about two million feet of film will be developed, of which only about ten thousand feet are selected for the final edited version of the film that is ultimately released to the viewing public. The excess film, contained in reels, is physically suitable for viewing, but represents superseded, redundant, or otherwise unwanted shots that the studio must either archive or dispose of. Film studios have historically regarded the unused film as a waste byproduct of the motion picture industry, leaving it to disintegrate slowly in a studio warehouse, or worse, to occupy space in a landfill.

Very little attempt, if any, has ever been made to convert this waste product into a valuable economic commodity. U.S. Pat. No. 5,956,877 to Raasch, et al. discloses a display device for a commemorative ticket. The device is a card containing a window for mounting a film negative, and is foldable at an angle to create two planar surfaces: a base for supporting the device on a horizontal surface, and a display surface for displaying the window to an onlooker. The device functions as a ticket, and includes various indicia related to the motion picture for which the negative was developed. Such a device, however, is commercially impractical, because it cannot easily be tailored to the needs of an individual theater. Movie theater tickets must be printed in mass, usually by a printing machine. Due to contractual concerns, the tickets must contain various information that is unique to each theater and show, such as time, price, location, special promotions, and any required legal disclaimers. It is simply not feasible to encumber a theater owner with specially engineered tickets that cannot be easily printed by conventional printing machines, or otherwise converted for local use.

While studio film crews continue to generate hundreds of millions of feet of unused film annually, studio film promoters endeavor to find innovative ways to attract audiences to view films in theaters, or purchase their films in VHS or DVD media. It is apparent from the foregoing discussion that the motion picture industry would benefit from an invention that could convert unused film into a useable commodity, especially one that could be exploited to promote the very motion picture for which the unused film was originally produced.

### SUMMARY

An article of memorabilia for promoting a motion picture, and methods for promoting motion pictures using the article of memorabilia are disclosed. In one embodiment, the article comprising a first plate, and a second plate attached to, and substantially equivalent in size to, the first plate. The second plate comprises a transparent portion. A film segment comprising one or more frames of film is substantially contained between the first and second plates, and a means is provided for attaching the first plate to a surface such that the film segment is viewable through the tranparent portion. In another embodiment, the article comprises a flexible band threaded through one or more slots in the first or second plate, forming a bracelet. The first and second plates may be substantially centrally located on the band, and the article may also comprise a means for illuminating the film segment.

In another embodiment, a method is disclosed for promoting public interest in viewing the motion picture for which the film was produced, the manufacturing and distribution of the article of memorabilia being an integral element of the method. One embodiment of the method comprises acquiring film shot for the motion picture, manufacturing one or more articles of memorabilia from a segment of the film, the segment comprising one or more frames of film, and disseminating the one or more articles of memorabilia to moviegoers to promote attendance at showings of the motion picture. One aspect of the invention includes disseminating the one or more articles of memorabilia to moviegoers attending a showing of the motion picture one or more light emitting diodes mounted to a lower plate comprising a housing. Other aspects of dissemination may include selling the articles, packaging the articles within VHS or DVD containers distributed for retail sale, or shipping the articles concurrently with the motion picture for distribution to moviegoers entering theaters.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A depicts a top view of one embodiment of an article of memorabilia according to the invention.

FIG. 1B depicts a side view of the embodiment of FIG. 1A.

FIG. 1C is a magnified side view of the article of FIG. 1A at its center.

FIG. 1D shows a film segment comprising three frames for containment within the article of FIG. 1A.

FIG. 2A illustrates one embodiment of an article according to the invention having illuminating means and a flexible band.

FIG. 2B illustrates another embodiment of an article according to the invention.

FIG. 3A shows a side view with manufacturing dimensions for one embodiment of an article according to the invention.

FIG. 3B shows a top view and dimensions for the article of FIG. 3A including identifying indicia affixed to a second plate.

FIG. 3C shows a die cut sticker for attachment to the second plate of FIG. 3B.

FIG. 3D shows a film segment for containment within the article of FIG. 3A.

FIG. 4A shows a top view of one embodiment of an article according to the invention having a film housing and illumination means.

FIG. 4B shows a side view of the article of FIG. 4A.

FIG. 4C shows a bottom view of the article of FIG. 4A.

FIG. 4D shows a detailed side view of the housing of FIG. 4A.

FIG. 4E shows a detailed top view of the housing of FIG. 4A.

FIG. 4F shows a detailed frontal side view of the housing of FIG. 4A.

FIG. 4G shows a detailed bottom view of the housing of FIG. 4A.

FIG. 5 illustrates one embodiment of a method for promoting motion pictures according to the invention.

FIG. 6 illustrates another embodiment of a method for promoting motion pictures according to the invention.

### DETAILED DESCRIPTION

As utilized herein, the terms “film” and “frame” and “film segment” denote small cuttings from a motion picture film, typically 35 mm in width, where the cuttings comprise one or more singular frames of visual images. As utilized herein, terms such as “about” and “substantially” and “approximately” are intended to allow some leeway in mathematical exactness to account for tolerances that are acceptable in the trade. Accordingly, any deviations upward or downward from the value modified by the terms “about” or “substantially” or “approximately” in the range of 1% to 20% should be considered to be explicitly within the scope of the stated value.

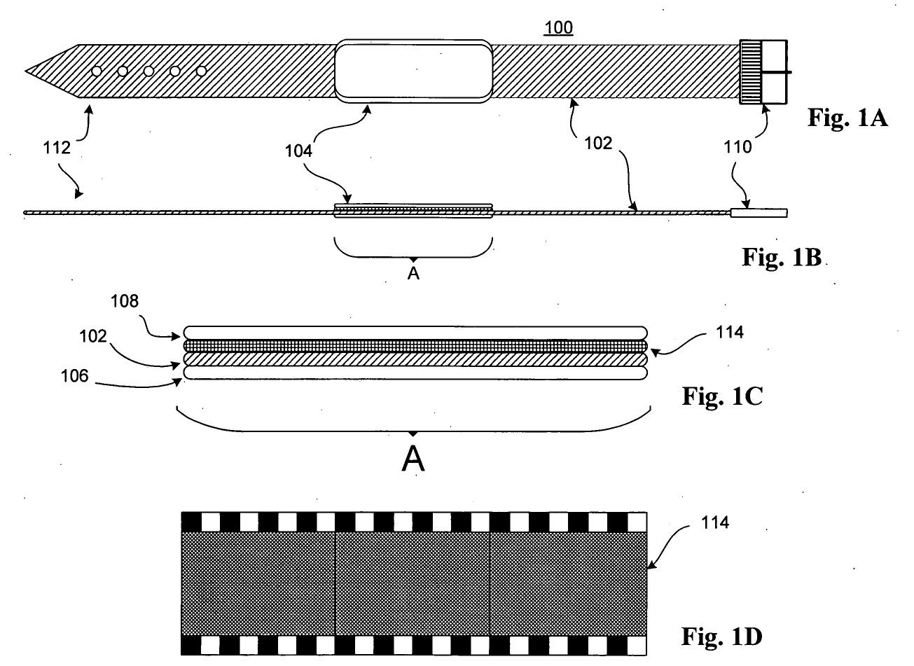

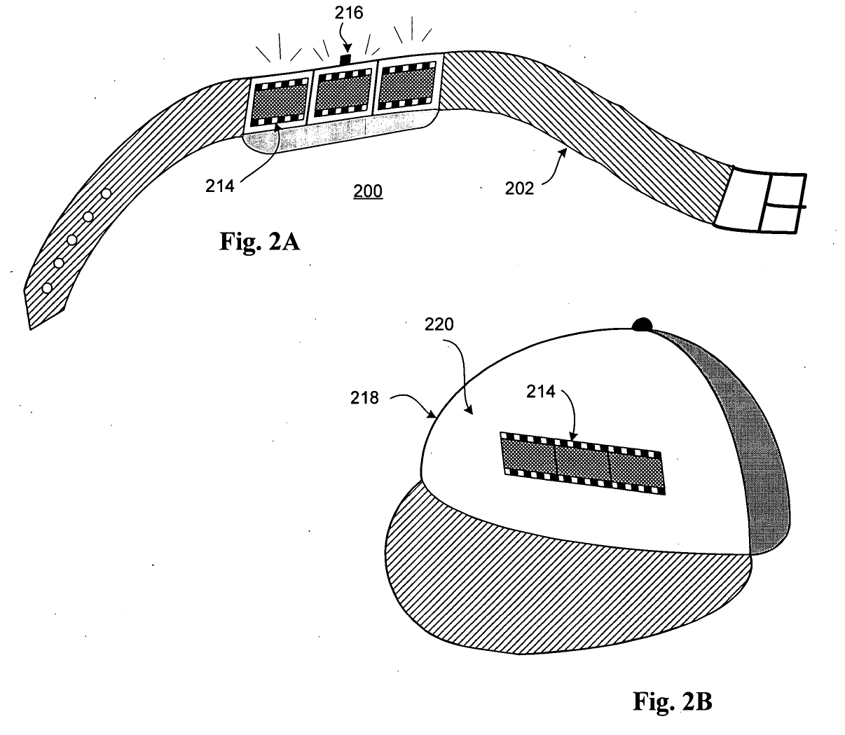

FIGS. 1A-1D illustrate an embodiment of an article of memorabilia according to the invention in the form of a bracelet 100. The bracelet has a flexible band 102 that supports a window assembly 104 substantially centrally located on band 102. Window assembly 104 has a first plate 106 and a second plate 108, which have substantially similar dimensions and which are generally rectangular in form. The width of plates 106 and 108 is about the same as the width of band 102, and may exceed the width of band 102 by a few millimeters on either side, preferably symmetrically.

Band 102 may comprise a single strip of material, or may comprise several strips joined together or joined at window assembly 104. Band 102 has a first end 110 and a second end 112 extending from either side of window assembly 104. First end 110 comprises a means for fastening to second end 112. In one embodiment, ends 110 and 112 have complimentary means for mating to one another, which may comprise any conventional means for providing an adjustable size bracelet. For example, as shown in FIG. 1A, first end 110 may comprise a sleeved buckle and pin arrangement, and second end 112 may comprise a tapered section and a series of holes positioned at intervals along its length beyond the taper. Or, ends 110 and 112 may have neither pin nor holes, such that the tapered second end simply threads through one or more slightly undersized slots in the first end, thereby joining the ends by means of friction and flexibility to create a tight connection. Any of the aforedescribed attachment means enables a moviegoer to attach an article of memorabilia according to the invention to his or her person easily by hand.

First plate 106 and second plate 108 may be composed of any material suitable for the purpose of containing a film segment 114 by pressing, clamping, fixing, or holding plates 106 and 108 together. Suitable materials for first plate 106 include metal (such as steel or aluminum) or plastic (such as PVC or polycarbonate). Suitable material for second plate 108 includes any transparent material that is sufficiently rigid to contain segment 114, such as clear polycarbonate plastic, glass, or plexiglass. First plate 106 and second plate 108 are sized to snugly accommodate a film segment 114 (i.e. a length of motion picture film) contained substantially between them, segment 114 comprising at least one frame of film, preferably one to three frames. Plates 106 and 108 may be attached by an adhesive, preferably a transparent adhesive, or they may be constructed to form a snap-lock seam. Optionally, first plate 106 may comprise longitudinal rectangular grooves (not shown) into which second plate 108 slides after insertion of film segment 114. First plate 106 may be attached to band 102 by an adhesive compound, or plate 106 may be configured with one or more sleeves for threading band 102 through. Other conventional means for attaching plate 106 and/or 108 to band 102 are possible, such as clips, rivets, or common fasteners. Plate 106 and/or plate 108 may also be attached to band 102 by threading band 102 through one or more slightly undersized slots provided in either or both plate 106 and plate 108.

FIG. 2A illustrates one embodiment of an article of memorabilia according to the invention comprising a flexible bracelet 200. Bracelet 200 comprises a band 202 which may be composed of any flexible or elastomeric material, such as synthetic rubber, cloth, leather, nylon, vinyl, canvas, or other plastic, textile, or fibrous material that is suitable for the purpose. In one embodiment, band 202 comprises PVC. Bracelet 200 further comprises one or more film segments 214, and a means 216 for illuminating film segments 214.

FIG. 2B illustrates another embodiment of an article of memorabilia according to the invention comprising a baseball cap 218. Cap 218 provides a convenient surface 220 for attaching a first plate (not shown) containing one or more film segments 214. Thus, one skilled in the art will readily recognize that potentially any article of clothing or apparel may comprise a surface for attaching an article of memorabilia according to the invention.

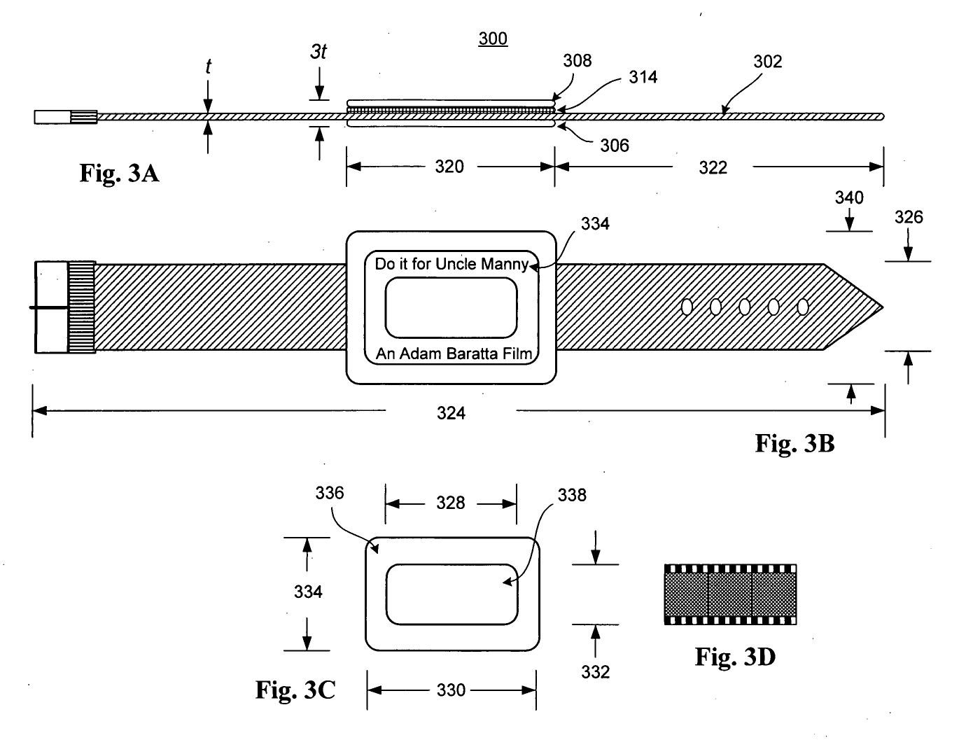

FIGS. 3A-3D illustrate an article of memorabilia according to the invention comprising a bracelet 300. As shown in the side view of FIG. 3A, bracelet 300 comprises a flexible band 302, a first plate 306, a second plate 308, and a film segment 314. Thickness t of flexible band 302 may fall within a range of about 0.5 to about 3 mm. First plate 306 and second plate 308 also each have a thickness t within this same range. Note that the thickness of film segment 314 lies below this range, thus, when film segment 314 is stacked together with band 302, first plate 306, and second plate 308, the total thickness of all four lies within the range of about 3t.

FIG. 3B shows a top view of bracelet 300 and some preferred manufacturing dimensions. Length 320 may be approximately 77 mm, length 322 may be approximately 140 mm, length 324 may be approximately 250 mm, width 326 may be approximately 40 mm, and width 340 may be approximately 45 mm. Bracelet 300 may further comprise optional identifying indicia 334 affixed to second plate 308 and framing images on film segment 314. Indicia 334 is preferably printed prominently in a manner that catches the eye, for example, in the form of raised red lettering. Indicia 334 is preferably printed on a die-cut, or pre-sized sticker 336 defining a hole 338 in its center that is approximately the same size as the viewable portion of film segment 314. Sticker 336 is placed on second plate 308 such that it surrounds, or frames, film segment 314. With reference to FIGS. 3C and 3D, other preferred manufacturing dimensions are shown. Length 328 may be approximately 57 mm, length 330 may be approximately 67 mm, width 332 may be approximately 25 mm, and width 334 may be approximately 42 mm.

The shot film which comprises raw material for memorabilia is original and not copied, therefore each film segment 314 used in a bracelet 300 or other article of memorabilia is unique in design. Indicia 334 is therefore functional in nature, in that it serves to identify the source of film segment 314. Indicia 334 may indicate, for example, the name of a motion picture, the name of a filmmaker, a frame and reel number, the image depicted, an actor or actress depicted, a quotation from the motion picture, a memorabilia serial number, or the name of a promotional event where the memorabilia was disseminated. Sticker 336 itself may be composed of any suitable material, such as plastic or paper with an adhesive backing. By using pre-sized stickers, articles of memorabilia according to the invention may be mass-produced, but specialized with unique characteristics by inserting film segments 314 and stickers 336 during final assembly.

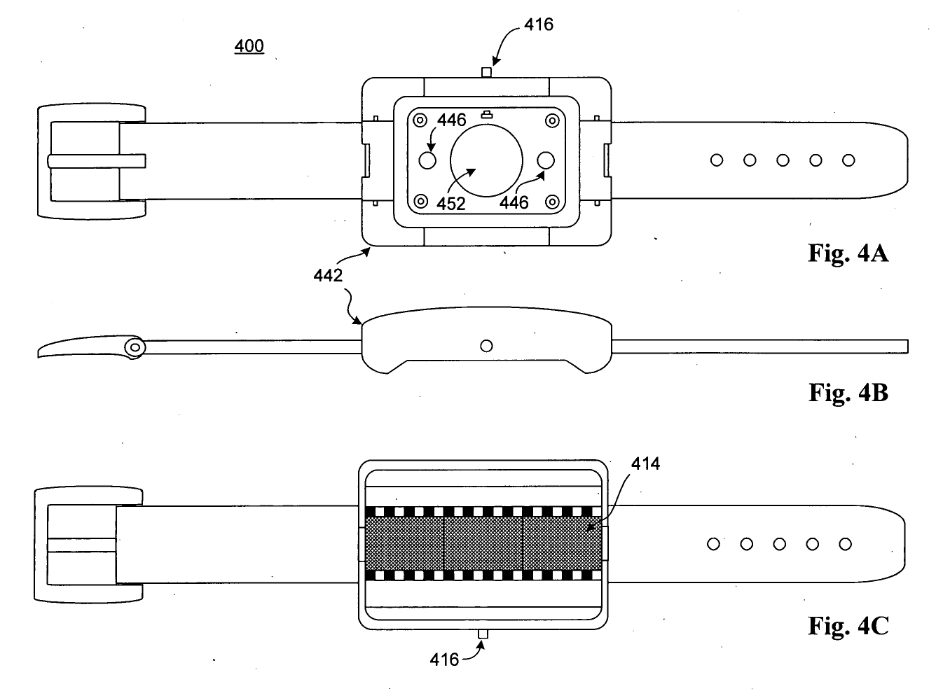

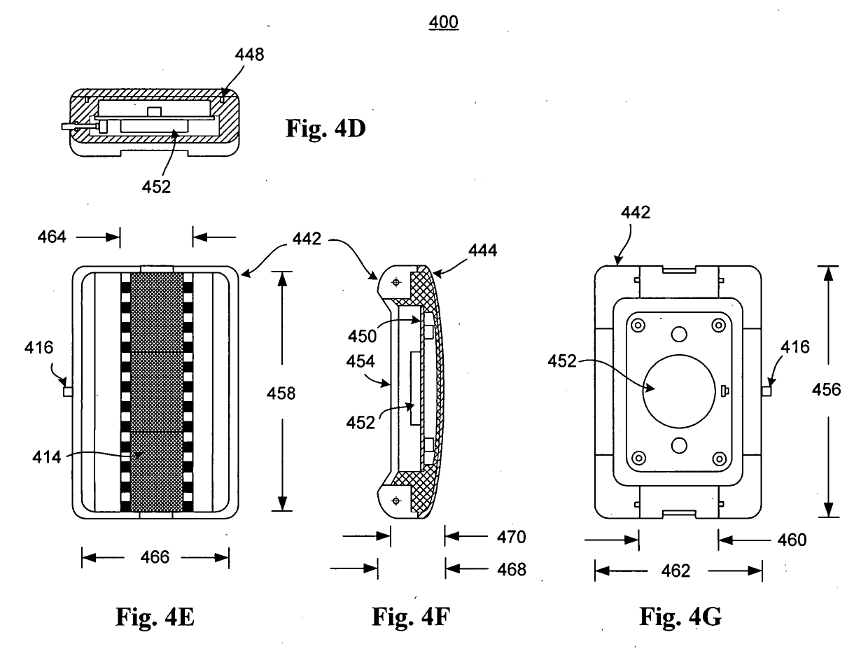

In another embodiment, depicted in FIGS. 4A-4G, an article of memorabilia according to the invention comprises a bracelet 400. In bracelet 400, the first and second plates are replaced with a housing 442, which contains a film segment 414 viewable through a transparent top cover 444. Housing 442 further comprises a means for illuminating a film segment 414. One or more light sources 446 such as light-emitting diodes (LEDs) are mounted to housing 442 and oriented in such a way that they illuminate images captured on one or more frames of film segment 414 sufficiently to be viewed with reasonable clarity through a transparent top cover 444. Housing 442 also comprises a means for enclosing the film, comprising, for example, top cover 444, fasteners 448, and board 450; one or more batteries 452 and battery holder(s) 454 for storing electrical energy; and a means for providing power to the light sources 446, such as a pushbutton switch 416 and conductors (not shown) for electrically coupling power from the one or more batteries 452 to light sources 446. In one embodiment, a portion of these conductors lie within board 450.

Housing 442 may be formed from metal or molded plastic, preferably the same or similar plastic used to form the first plate, and top cover 444 may be composed similarly as the second plate, as previously disclosed. Other components such as light sources 446, fasteners 448, board 450, batteries 452, battery holder 454, and other components shown but not described, may be composed of any commercially available materials well known in the art.

In one embodiment, board 450 comprises a printed circuit board. The top of board 450 functions as a first plate to support film segment 414. Board 450 also provides mounting locations for LEDs 446, and electrical conductors (not shown) for coupling LEDs 446 to one or more batteries 452. Batteries 452 may be contained within a volume on the bottom of the housing by battery holder (i.e. battery door) 454, and holder 454 may be configured with electrical conductors necessary to couple the terminals of batteries 452 to board 450 or directly to LEDs 446. Batteries 452 are preferably of the flat disc variety, and may be nickel-cadmium, lithium, or any other conventional type having sufficient voltage, typically 0.7 volts or greater, in series combination if necessary, to power LEDs 446. Suitable fastening means, such as adhesives, snap-lock configurations, or conventional hardware, are used to connect board 450 and holder 454 to housing 442.

With reference to FIGS. 4E-4G, some preferred manufacturing dimensions for housing 442 are also shown. Length 456 may be approximately 61.5 mm, length 458 may be approximately 57 mm, width 460 may be approximately 19.5 mm, width 462 may be approximately 44 mm, width 464 may be approximately 25 mm, width 466 may be approximately 40 mm, height 468 may be approximately 17.6 mm, and height 470 may be approximately 14.5 mm.

The invention for creating memorabilia comprising shot, developed, undeveloped, or unused segments of film is in no way limited to the aforedescribed embodiments in bracelets. Other embodiments of the invention comprising film segments mounted to a flexible band, or film segments mounted within a housing, include various articles of apparel and collectibles such as hats, pins, badges, buttons, necklaces, t-shirts, cards, displays, desktop items, and the like. In another embodiment, the memorabilia containing film segments comprises a movie ticket.

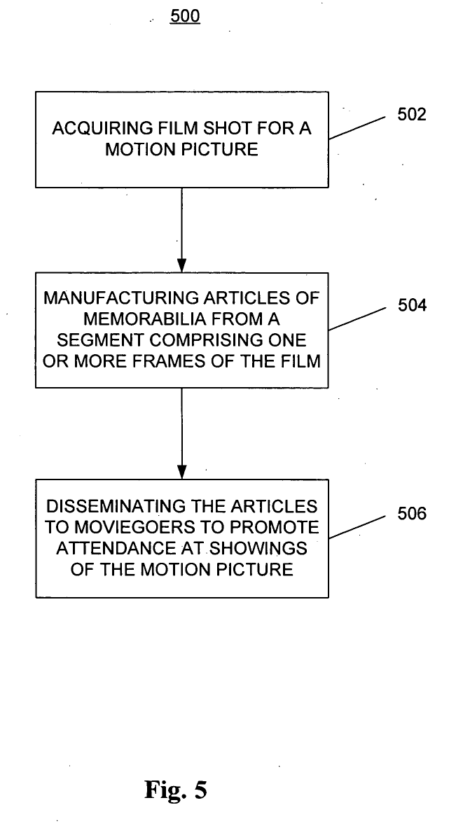

FIG. 5 illustrates an embodiment of a method 500 according to the invention for promoting public interest in motion pictures, or more specifically, for promoting attendance, viewings, and/or sales of motion pictures. Method 500 may be advantageously employed prior to, or concurrently with, a public release of a motion picture using memorabilia derived from unused film shot during production of the same picture. The method begins with step 502, wherein a practitioner of the method (e.g. a promoter, marketer, salesman, distributor, or agent of a movie studio), acquires film in any form—used, unused, edited, developed, undeveloped—that was shot during production of a motion picture and that has captured a viewable image. In one embodiment, the acquired film is in the form of one or more reels that were shot, developed, and used in the final version of the motion picture. In another embodiment, the acquired film is in the form of one or more reels of undeveloped negative frames shot during production of the film, but for whatever reason were not used in the final edited version of the film. In one aspect of step 502, the acquiring step may comprise shooting the film. In another aspect, the practitioner may acquire title to the unused film by purchasing or other means, or may simply acquire rights to possession and use thereof by licensing the rights for promotional purposes. In the next step 504, the practitioner manufactures one or more articles of memorabilia from a segment of the acquired film, wherein the segment comprises one or more viewable frames. The memorabilia may be in the form of any of the aforementioned embodiments. Finally, in step 506, the practitioner disseminates the one or more articles of memorabilia to moviegoers to promote the motion picture, for example, by giving the articles away freely to promote attendance at showings of the motion picture. The disseminating step may occur prior to, or concurrently with, private or public the release of the film in movie theaters or in a home-viewing format such as VHS or DVD.

There are many other options available for executing step 506, for example, step 506 may comprise dissemination by selling the memorabilia at a premier showing of the movie, by selling or giving away the memorabilia at a promotional event, by packaging the memorabilia within VHS or DVD containers and distributing them for retail sale, by selling the memorabilia to a movie distributor or to another third party distributor, or by delivering the memorabilia concurrently with the general release of movie reels to movie theaters for eventual sale to moviegoers as they enter or exit the theater.

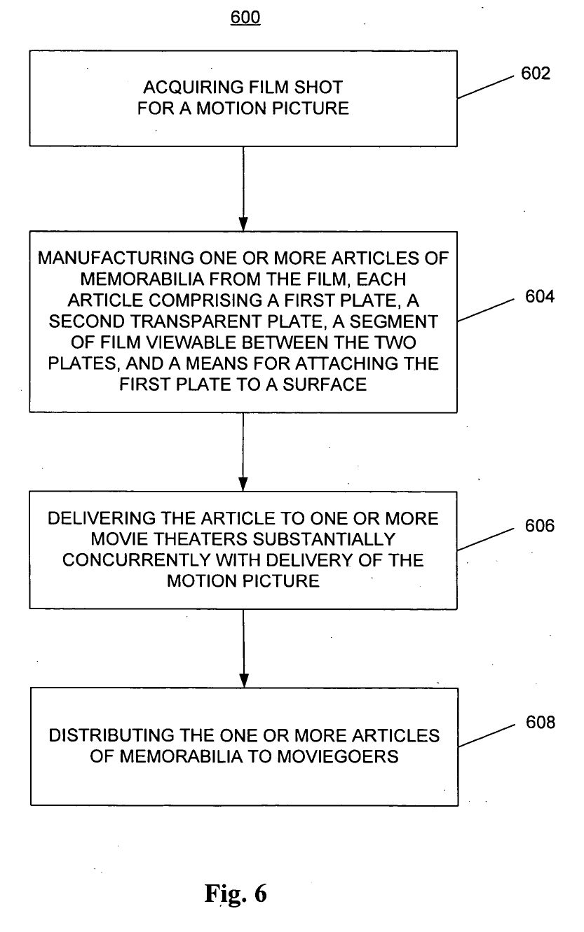

FIG. 6 illustrates another embodiment of a method 600 according to the invention for promoting motion pictures. The first step 602 is identical to the acquiring step 502 of method 500. The next step 604 comprises manufacturing one or more articles of memorabilia from the acquired film, wherein the memorabilia comprises a first plate, a second transparent plate attached to the first plate, a segment of the film contained between the two plates and viewable through the second plate, and a means for attaching the first plate to a surface. In the next step 606, the method further comprises delivering the one or more articles of memorabilia to one or more movie theaters substantially concurrently with the delivery of the motion picture. The final step 608 comprises distributing the one or more articles of memorabilia to moviegoers attending the one or more theaters. Step 608 may comprise distributing articles at or near a theater, or distributing as moviegoers enter or exit the a theater, or distributing articles directly or indirectly to potential moviegoers by mail or by some other means. In one embodiment, distributing step 608 comprising selling the one or more articles to moviegoers.

The invention has been presented in an illustrative style. The various terminology employed throughout should be read in an exemplary rather than a limiting manner. Although some disclosure has been provided for dimensions of various components, other details and dimensional relationships that have not been fully described may be easily ascertained by those skilled in the art after a thorough reading of the disclosure. Accordingly, while various embodiments of the invention have been described, it will be apparent to anyone familiar with methods of promoting motion pictures by means of disseminating memorabilia that the present invention may be practiced in ways other than as specifically described herein, including variations on the memorabilia device itself, as well as variations on the promotional method.

1. An article of memorabilia for promoting a motion picture, comprising:
a first plate;
a second plate attached to, and substantially equivalent in size to the first plate, the second plate having a transparent portion;
a film segment comprising one or more frames of film, the film segment substantially contained between the first and second plates; and
a means for attaching the first plate to a surface, such that the film segment is viewable through the transparent portion.

2. The article of claim 1 wherein the surface comprises a flexible band.

3. The article of claim 2 wherein the attaching means comprises one or more slots in the first plate for threading the flexible band through the first plate.

4. The article of claim 2 wherein the first and second plates are substantially centrally located on the flexible band.

5. The article of claim 2 wherein the flexible band further comprises first and second ends, the first end having means for fastening to the second end.

6. The article of claim 1 wherein the first plate further comprises a means for illuminating the film segment.

7. An article of memorabilia for promoting a motion picture, comprising:
a first plate;
a second plate attached to, and substantially equivalent in size to the first plate, the second plate having a transparent portion;
a segment of film shot during filming of the motion picture, the film segment comprising one or more frames of film, the film segment substantially contained between the first and second plates;
a means for illuminating the film segment; and
a means for attaching the first plate to a surface, such that the film segment is viewable through the transparent portion.

8. The article of claim 7 wherein the surface comprises an article of apparel, and wherein the attaching means enables a moviegoer to attach the article of memorabilia to the article of apparel by hand.

9. The article of claim 8 wherein the attaching means further comprises one or more slots for threading a flexible band through the first or second plate.

10. The article of claim 9 wherein the first and second plates are substantially centrally located on the flexible band, and wherein the flexible band further comprises first and second ends, the first end having means for fastening to the second end.

11. A method for promoting a motion picture, comprising:
acquiring film shot for the motion picture;
manufacturing one or more articles of memorabilia from a segment of the film, the segment comprising one or more frames of the film; and
disseminating the one or more articles of memorabilia to moviegoers to promote attendance at showings of the motion picture.

12. The method of claim 11 further comprising disseminating the one or more articles of memorabilia to moviegoers attending a showing of the motion picture.

13. The method of claim 11 wherein the acquiring step comprises shooting the film.

14. The method of claim 11 wherein the acquiring step comprises acquiring rights to possession and use of the film through licensing.

15. The method of claim 11 wherein the disseminating step further comprises selling the one or more articles of memorabilia at a premier showing of the motion picture.

16. The method of claim 11 wherein the disseminating step further comprises packaging one or more of the articles of memorabilia within VHS or DVD containers, and distributing the containers for sale.

17. The method of claim 11 wherein the disseminating step further comprises:
delivering to one or more movie theaters, concurrently with delivery of the motion picture, one or more of the articles of memorabilia; and
distributing one or more of the articles of memorabilia to moviegoers attending the one or more theaters.

18. The method of claim 11 wherein the manufacturing step comprises manufacturing one or more articles of memorabilia, each article comprising:
a first plate;
a second plate attached to, and substantially equivalent in size to the first plate, the second plate having a transparent portion;
a film segment comprising one or more frames of the film, the film segment substantially contained between the first and second plates; and
a means for attaching the first plate to a surface, such that the film segment is viewable through the transparent portion.

19. The method of claim 11 wherein the manufacturing step comprises manufacturing one or more articles of memorabilia, each article comprising:
a first plate;
a second plate attached to, and substantially equivalent in size to the first plate, the second plate having a transparent portion;
a film segment comprising one or more frames of the film, the film segment substantially contained between the first and second plates;
a means for illuminating the film segment; and
a means for attaching the first plate to a surface, such that the film segment is viewable through the transparent portion.

20. The method of claim 19,
wherein the surface comprises a flexible band;
wherein the attaching means comprises one or more slots for threading the flexible band through the first or second plate;
wherein the first and second plates are substantially centrally located on the flexible band; and
wherein the flexible band further comprises first and second ends, the first end having means for fastening to the second end, thereby enabling a moviegoer to attach the article of memorabilia his or her person by hand.
